(19) United States
(12) Patent Application Publication
(10) Pub. No.: US 2004/0025538 A1
(43) Pub. Date: Feb. 12, 2004

(54) Method and device for moulding the base of a glass container

(76) Inventors: Christian Kunert, Maniz (DE); Andreas Langsdorf, Ingelheim (DE); Friedrich Lampart, Heiden (CH); Heinz Franz, Lebanon, PA (US); Roman Oberhänsli, Bischofsfeld (CH)

Correspondence Address: Todd T Taylor, Taylor & Aust, 142 S Main Street, PO Box 560, Avilla, IN, 46710, US

(21) Appl. No.: 10/362,045

(22) PCT Filed: Jul. 14, 2001
(86) PCT No.: PCT/EP01/08136

(30) Foreign Application Priority Data
Aug. 19, 2000 (DE) 100 40 675.0

(51) Int. Cl. C03B 23/00

(52) U.S. Cl. 65/102; 65/305; 65/286; 65/269

(57) ABSTRACT

An method and apparatus for shaping a floor of a glass vessel including a source of pressurized gas, a pressure-sealed housing in fluid communication with the source of pressurized gas and a mold at least partially within the pressure-sealed housing. The mold includes a shaping floor with a first side subjected to the source of pressurized gas.

The invention relates to glass vessels, especially for pharmaceutical applications such as test tubes, Erlenmeyer flasks, small bottles for pharmaceuticals and the like.

Glass vessels, especially such for pharmaceutical purposes, are frequently made of tubes made of special glass. Usually, the orifice region of the vessel is shaped first in the respective machines. Thereafter the produced bottle is severed from the glass tube according to its length and then molten together at its end. Thereafter the floor region is heated up to a temperature at which the glass is easily deformable. Then the floor shape is usually set by means of a stamp which presses onto the soft floor, as is shown for example in DE 1 261 638 B. It is the task of the stamp to ensure that the bottles are situated within the required dimensional tolerances with respect to their height and the recess in the middle of the floor. At the same time, the stamp ensures that the bottle can stand in a stable fashion on a plane base.

A large variety of materials are used as stamp materials which are capable of withstanding the prevailing temperatures and are sufficiently resistant against abrasion, e.g. various ceramic materials such as ceramically bound SiC. Graphite is usually not used because the soft graphite will wear off too quickly as a result of the continual frictional wear and tear and is therefore unable to maintain any constant geometry over longer periods of time.

Since the contact surface of the stamp is in direct contact with the rotating soft floor of the bottle during the shaping, even tiny irregularities in the stamp will appear as grooves in the floor of the bottle. Moreover, the contact surface of the stamp will wear off during the application as a result of continual frictional wear and tear. The occurring grooves can impair the mechanical strength of the bottle and thus impair the overall appearance, so that the stamp needs to be exchanged from a certain level of wear and tear. In addition to the aesthetic aspects, the grooves in the floor of the bottle prevent an automatic visual inspection of the vessels that are filled subsequently by the pharmacist because the grooves and irregularities in the floor of the bottle will be interpreted as impurities in the content. As a result, a large number of vessels would erroneously be sorted out and rejected.

An alternative method for shaping floors as described for example in DE 1 127 042 B in which the explained disadvantages are avoided provides free shaping of the floor. In this process, the floor of the bottle is shaped without any pressing of a stamp. The bottle which is readily shaped in the orifice region is severed from the remainder of the tube according to its required height and is molten together. By providing a precise setting of the burner it is possible to attach a floor to the bottle without allowing the floor to come into contact with shaping material. The floor comprises a fire-polished surface and is clearly transparent.

Bottles which are produced by free shaping of the floor by means of burners show higher dimensional tolerances than bottles whose floor is shaped by means of a floor stamp. As a result, the height of the bottles fluctuates relatively strongly in the case of freely shaping the floors. Furthermore, the floor is not shaped in such a way that it ensures stability of the bottle or vessel. Any fluctuations or irregularities arising from the severing and heating process are not corrected, other than is the case when using a stamp.

The invention is based on the object of providing a method and an apparatus with which the floor of a glass vessel can be shaped in a cost-effective, cheap and quick manner in such a way that the advantages of shaping floors with a stamp on the one hand and the free shaping of floors with burners on the other hand are combined with each other. Floors with narrow dimensional tolerances are to be produced in this way which simultaneously also provide a clear transparency which offers a visual inspection of the later content in an automatic manner too.

This object is achieved by the features of the independent claims.

Although a stamp is used in accordance with the invention as a matrix for shaping the floor, any contact between the shaping surface of the stamp and the floor of the vessel is prevented by the gas cushion. Due to the lack of direct contact between the hot glass and the stamp, injury to the glass surface is prevented. As a result, there are no damage, grooves or irregularities. At the same time, wear and tear of the stamp is prevented. The surface of the vessel floor is similar to a fire-polished surface and is clearly transparent.

In the practical realization of the invention the said glass stamp will be a general component of an apparatus. Preferably, the side of the apparatus facing the glass floor to be shaped consists of a porous material of low pore size through which the gaseous medium is allowed to flow and can thus be supplied evenly over the entire surface to be shaped.

The floor shaping process then proceeds according to the following steps for example:

1. The floor region of the bottle is brought to a temperature in one or several preceding steps at which deformation is easily possible. The viscosity of the glass in the floor region of the vessel is then between 10¹⁰ dPas and 10³ dPas.

2. The apparatus in accordance with the invention is moved towards the softened floor from the side opposite of the orifice of the bottle.

3. At places at which the distance between the soft floor and the apparatus is smaller than approx. 100 μm the soft glass is displaced by the gas film.

4. During progressing approach of the apparatus towards the floor, an increasingly larger part of the floor rests on the shaping surface of the apparatus which is covered by the gas film, whereby the gas film prevents any direct contact.

5. In an end position which depends on the desired geometry, the bottle and the apparatus are held for such a time until the floor has cooled off to such an extent that it no longer deforms during further processing.

6. Thereafter the shaped vessel is removed from the floor shaping station. Preferably, the vessel rotates during the entire process. The floor of the upside-down bottle is located at the top and the apparatus is led up from above. Other arrangements are also possible.

As a result of the processes as described in steps 3 and 4 it is possible to compensate fluctuations in the process which would lead to a departure from the permissible dimensional tolerances such as a slight over-length of the vessel during the severing from the tube. In the case of a free shaping of the floor, the process fluctuations would lead to a departure from the required tolerances because the corrective influence of the floor shaping apparatus is missing.

The shaping surface of the apparatus in accordance with the invention can be made of virtually any desired material which can be obtained with a sufficient gas permeability. Preferably, porous graphite is used, more preferably with pore sizes <50 μm, because graphite, due to its very low bonding tendency and a very low coefficient of sliding friction, only leads to minimal damage of the vessel floor even in the case of unintended contacts between the shaping surface and the glass floor, but not to any destruction of the apparatus. The low pore size allows producing the shaping surface with a high surface quality.

Alternatively, it is possible to use porous ceramic materials such as SiC, Al₂O₃, mullite or porous metals such as CrNi steels, bronzes or Ni-based alloys as well as ceramic materials or metals coated with protective, anti-stick or sliding layers. These are used when application temperatures higher than 600° C. and/or higher mechanical strengths are required. Important is the gas permeability at a sufficiently fine porosity, preferably <50 μm, more preferably <20 μm pore diameter. Coarser pores would lead to the consequence that the gas film could be broken through locally, thus leading to local contact between the glass and the shaping surface and to damage of the floor to be shaped and possibly also the apparatus.

The employed gas will usually be compressed air for cost reasons. It is available at a reasonable price. Moreover, there will not be any undesirable changes to the surface of the glass. If reactions between the gas and the glass surface are to be produced intentionally, it is also possible to use reactive gases. For example, the use of SO₂ is possible when a coating of NaSO₄ is to be produced on the surface which subsequently prevents the scratching of the bottle floors during subsequent transport. Moreover, inert gases such as nitrogen or argon can be used when higher temperatures are desirable on the shaping surface. The protective gases then prevent the early oxidation and destruction of the shaping surface.

In a preferred embodiment, groove-like recesses are incorporated in the shaping surface. They can extend radially over the shaping surface or form one or several spirals. The precise arrangement of the recesses concerning number and shape depends on the respective purpose. These recesses ensure that although the gas emerging from the face surface is available locally for forming the gas film and prevents any contact between glass and shaping surface, it can still be guided off in a controlled fashion into the recesses. Without such recesses, a congestion of air between the shaping surface and the soft glass floor can occur especially in larger floor diameters. This would produce an uncontrolled shaping of the floor of the vessel.

The invention is explained in closer detail by reference to the enclosed drawings, wherein:

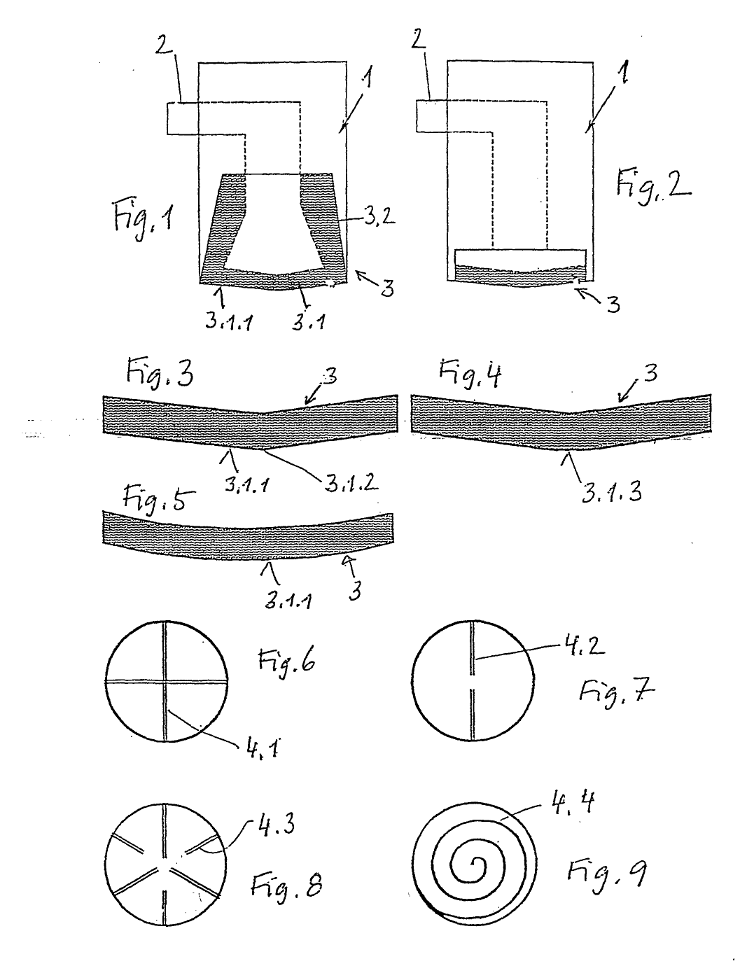

FIG. 1 shows an apparatus in accordance with the invention in an axial section view;

FIG. 2 shows another embodiment of such an apparatus, again in an axial sectional view;

FIGS. 3 to 5 show various embodiments of the shaping parts of apparatuses in accordance with the invention.

FIGS. 6 to 9 show top views of shaping surfaces of apparatuses in accordance with the invention, but on a reduced scale relative to the representations according to FIGS. 3 to 5.

The apparatus as shown in FIG. 1 comprises a pressure-sealed housing 1 with a gas connection 2 as well as a mould 3. The mould 3 comprises a floor 3.1 as well as a cylindrical wall 3.2 which is sealed by the pressure-tight housing on the cylinder surface. The shaping floor 3.1 comprises a shaping surface 3.1.1.

The mould 3 is inserted in this case exchangeably in the housing 1. It can thus be exchanged against moulds with different shaped shaping surfaces. An example for such another configuration of the mould 3 is shown in FIG. 2.

The material of mould 3 comprises a plurality of open pores. When gas is introduced under pressure through the gas connection 2 into the apparatus, the gas emerges through the open pores at the shaping surface 3.1.1.

During operation, an apparatus of the kind mentioned above and a glass vessel with a floor to be shaped are brought together in such a way that these two are in alignment with each other with their longitudinal axes. A glass vessel is not shown in the present case.

The apparatus and the glass vessel are approached towards each in the direction of their axes. Pressurized gas is then introduced through the gas connection 2 into the apparatus. It emerges from the shaping surface 3.1.1 and forms a gas cushion which remains between the shaping surface 3.1.1 and the floor to be shaped and acts upon the floor to be shaped within the terms of the intended shaping.

Even if there is no direct contact between the shaping surface 3.1.1 on the one part and the floor of the vessel to be shaped on the other part, the illustrated apparatuses can still be designated as a stamp.

In the embodiment according to FIG. 3 the mould merely contains a plate 3 which is circular in a top view and substantially corresponds to the shaping floor 3.1 of FIG. 1.

In all other aspects the work process of the apparatus according to FIG. 2 is the same as that according to the apparatus of FIG. 1.

FIG. 3 shows a mould 3 in analogy to that of FIG. 2, but on an enlarged scale. One can clearly recognize the conical shape with the tip 3.1.2 in the centre.

The mould 3 according to FIG. 4 shows a flattened portion 3.1.3 in the centre instead of the tip.

The shaping surface 3.1.1 of the mould 3 according to FIG. 5 has the shape of a spherical cap.

FIGS. 6 to 9 show in an exemplary fashion a number of possibilities of recesses or grooves 4.1, 4.2, 4.3 and 4.4. The recesses can be groove-like. They can extend radially over the shaping surface. The can comprise one or several spirals. The precise configuration of the recesses as well as their number and shape depend on the respective purpose. The recesses ensure that although the gas emerging from the face surface is available locally for forming the gas film and prevents any contact between glass and shaping surface, it can still be guided off in a controlled fashion into the recesses.

Without such recesses, a congestion of air between the shaping surface and the soft glass floor can occur especially in larger floor diameters. This would produce an uncontrolled shaping of the floor of the vessel.

1. A method for shaping the floor of a glass vessel with the following method steps:
1.1 the floor is freely subjected in the hot-forming state to the shaping pressure of a stamp;
1.2 gas is pressed by pressurization into the intermediate space between the shaping surface (3.1.1) and the floor of the glass vessel through the shaping surface (3.1.1) of the stamp (3) which comprises a fine porosity of <50 μm in order to produce a gas cushion during the pressing;
1.3 at an end position which depends on the desired geometry the glass vessel and the shaping surface (3.1.1) of the stamp are held for a sufficiently long time until the floor has cooled off to such an extent that it no longer deforms during the subsequent process.

2. A method as claimed in claim 1, characterized in that the floor region of the glass vessel is brought in one or several steps to a temperature which allows a deformation.

3. An apparatus for shaping the floor of a glass vessel;
3.1 with a stamp (3) which applies a mould mark on the floor of the glass vessel in its hot-forming state;
3.2 the stamp (3) or its shaping surface (3.1.1) consists of porous material with a porosity <50 μm;
3.3 a device for forming a gas flow through the porous material of the shaping surface (3.1.1) of the stamp (3) is provided in order to form a gas cushion between the shaping surface (3.1.1) and the floor of the glass vessel.

4. An apparatus as claimed in claim 3, characterized in that the shaping surface (3.1.1) is arranged as a cone.

5. An apparatus as claimed in claim 3, characterized in that the shaping surface (3.1.1) is arranged as a truncated cone.

6. An apparatus as claimed in one of the claims 3, characterized in that the shaping surface (3.1.1) is arranged as a spherical cap.

7. An apparatus as claimed in one of the claims 3 to 6, characterized in that the shaping surface (3.1.1) is provided with recesses and/or elevations in such a way that gas can flow off from the gas cushion in a controlled manner via the recesses.

8. An apparatus as claimed in claim 7, characterized in that the elevations or recesses are disposed and arranged in a groove-like, radial or spiral fashion.
